(19) United States
(12) Patent Application Publication
(10) Pub. No.: US 2008/0041638 A1
(43) Pub. Date: Feb. 21, 2008

(54) Low Profile Load Cell

(76) Inventor: Gerald S. Simons, Toronto (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/761,774

(22) Filed: Jun. 12, 2007

Related U.S. Application Data
(63) Continuation-in-part of application No. 11/282,253, filed on Nov. 18, 2005.
(60) Provisional application No. 60/812,585, filed on Jun. 12, 2006.
(60) Provisional application No. 60/704,516, filed on Aug. 1, 2005.

(51) Int. Cl. G01G 21/00

(52) U.S. Cl. 177/210 FP

(57) ABSTRACT

The invention includes a load cell which has a base, a contact knob and a strain gauge measuring device. When the contact knob supports an object, the base flexes, which is detected by the measuring device, and used to provide a weight of the object to a person interested in knowing the weight.

### CROSS-REFERENCE TO RELATED APPLICATION

This application claims the benefit of priority to U.S. provisional patent application Ser. No. 60/812,585 filed on Jun. 12, 2006. This application is a continuation-in-part of U.S. patent application Ser. No. 11/282,253 filed Nov. 18, 2005, which claims the benefit of U.S. provisional patent application 60/704,516 filed Aug. 1, 2005.

### FIELD OF THE INVENTION

The present invention relates to devices for measuring the weight of objects.

### BACKGROUND OF THE INVENTION

There are many situations in which it is desired to know the weight of an object. For example, when lifting a pallet, a forklift truck driver would like to know the weight of the pallet and/or the objects on the pallet in order to load the proper amount of the objects into a delivery truck. Or, it may be beneficial to know the weight being supported by a floor so that an alarm may be sounded when the weight supported by the floor exceeds a safe level. Further, the weight of vehicles is often needed in order to determine taxes due for driving on roadways or the cost of the goods being carried by the vehicle.

Often, weight sensors are placed in locations which allow for indirect measurement of the weight of objects being supported from a platform, such as a pallet or a floor. Indirect measurement is not very accurate, and usually requires complex devices to determine the weight. In other situations, weight sensors are placed directly beneath an object, but these mechanisms for supporting and measuring the weight of an object, such as a truck, are large and costly.

As such, there is a need for a load cell that is capable of directly measuring the weight of an object, and which is both inexpensive and occupies a small amount of space.

### SUMMARY OF THE INVENTION

The invention may be embodied as a load cell. The load cell may have a base, a contact knob and a strain gauge measuring device. The strain gauge measuring device is fixed to the base, and includes at least one strain gauge. A transmission device capable of transmitting a signal from the strain gauge measuring device to an analyzing circuit may be used to provide electric power to the strain gauge and to receive indications of resistance from the strain gauge. The analyzing circuit may be a voltmeter. The voltmeter may be electrically coupled to a computer which is programmed to correlate changes indicated by the voltmeter to a weight, and also programmed to cause a monitor to indicate a weight to a person having a desire to know the weight.

The contact knob may have a rounded surface. Furthermore, the contact knob may be an integral part of the base. However, the contact knob may be a distinct part, which is fixed to the base. The contact knob may be located on a side of the base that is different from the side of the base to which the strain gauge is attached.

The invention may be embodied as a method of weighing an object. In one such method, a load cell is provided. For example, the load cell may have a base, a contact knob and a strain gauge measuring device fixed to the base. A first resistance of the strain gauge measuring device may be measured. Then an object to be weighed may be supported with the contact knob. With the object supported by the contact knob, a second resistance of the strain gauge measuring device is measured. The first resistance and the second resistance are compared to obtain a resistance difference, and the resistance difference is correlated to a weight. The weight is then displayed to a person.

### BRIEF DESCRIPTION OF THE DRAWINGS

For a fuller understanding of the nature and objects of the invention, reference should be made to the accompanying drawings and the subsequent description. Briefly, the drawings are:

FIG. 1a, which is a plan view of a load cell according to the invention;

FIG. 1b, which is a cross-sectional side view of the load cell depicted in FIG. 1a;

FIG. 1c, which is a cross-sectional side view of a load cell in which the contact knob and base are separate pieces fixed to each other.

FIG. 2a, which is a plan view of a load cell according to the invention;

FIG. 2b, which is a side view of the load cell depicted in FIG. 2a;

FIG. 2c, which is a cross-sectional side view of a load cell in which the contact knob and base are separate pieces fixed to each other, and in which the base is comprised of more than one piece.

FIG. 3, which is a plan view of a fork lift truck using the invention;

FIG. 4, which is a cross-sectional side view of a forklift tine, taken from the section 4--4 in FIG. 3; and

FIG. 5, which depicts a method according to the invention.

### FURTHER DESCRIPTION OF THE INVENTION

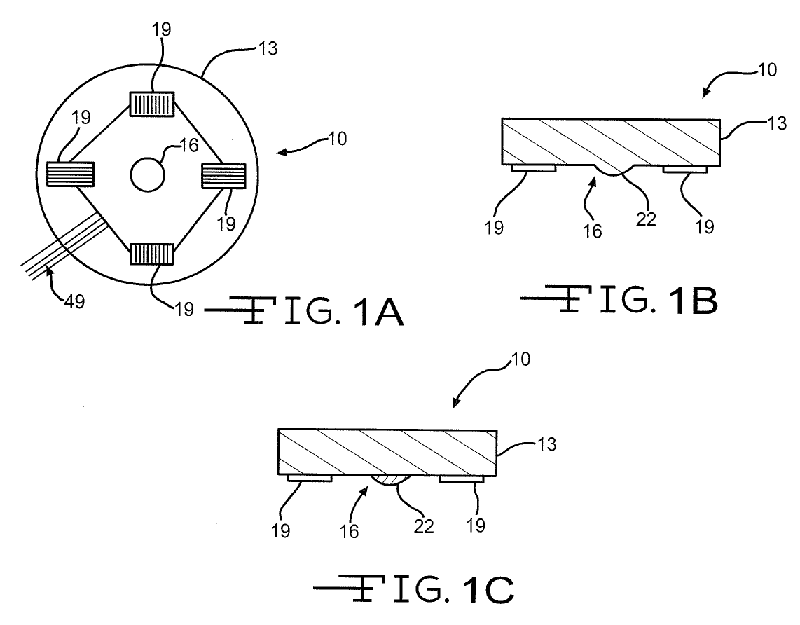

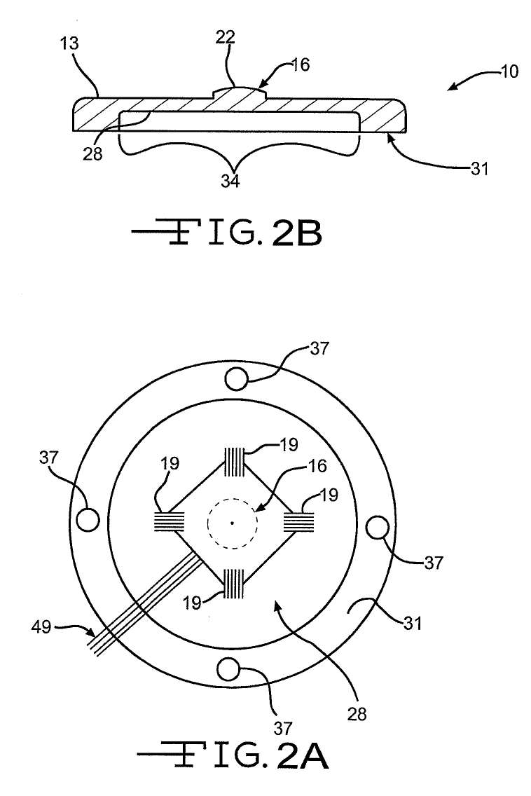

The invention may be embodied as a load cell 10 for weighing one or more objects. FIGS. 1a and 1b show a load cell 10 according to the invention. This load cell 10 has a base 13, and extending from the base 13 is a contact knob 16. One or more strain gauges 19 may be fixed to the base 13 and electrically connected to form a Wheatstone bridge.

The base 13 in FIGS. 1a and 1b is disk shaped, but the invention is not limited a such a shape. FIG. 1a shows the base 13 has a circular shape when viewed in a first direction, and FIG. 1b indicates that the cross-section of the base 13 may be substantially rectangular when viewed from a second direction that is substantially perpendicular to the first direction. FIGS. 1a and 1b show the base 13 made from a single piece of material, but more than one piece of material may be used to form the base 13.

The contact knob 16 of the load cell 10 may include a rounded surface 22 in order to prevent twisting of the load cell 10. The rounded surface 22 may be particularly useful when the base 13 of the load cell 10 is not parallel to the surface which contacts the contact knob 16. The rounded surface 22 of the contact knob 16 accommodates non-linear loading of the load cell 10, and thereby reduces signal errors normally experienced when a load cell 10 is loaded in a non-linear fashion.

FIG. 1b shows an embodiment of the load cell 10 in which the base 13 and contact knob 16 are formed from the same material to provide an integral unit. The base 13 and contact knob 16 may be made of metal. FIG. 1c shows an embodiment in which the base 13 and the contact knob 16 are formed separately, and then attached to each other by welding the contact knob 16 to the base 13. The invention is not limited to welding the contact knob 16 to the base 13, and it will be recognized that other means of attaching may be used, such as through the use of an adhesive.

When the weight of an object is placed on the load cell 10, the weight is supported by the contact knob 16, and the base 13 is caused to flex. Flexing of the base 13 changes the resistance afforded by the strain gauges 19, and these changes may be sensed by suitable detection equipment, such as a voltmeter 25. When a voltmeter 25 is used as the detection equipment, the voltage change may be correlated to a weight and that correlated weight may be displayed to a person having an interest in knowing the weight of the object.

FIG. 1a depicts an embodiment in which a plurality of strain gauges 19 are mounted to the base 13 at locations that are radially further from a central location of the base 13 than the edges of the contact knob 16. However, it will be recognized that the strain gauges 19 need not be located in this fashion in order to practice the invention.

The strain gauges 19 may be the metal film type. Although shown in FIGS. 1a and 1b on the same side as the contact knob 16, other embodiments of the invention place the strain gauges 19 on a side of the base 13 that is opposite from the side where the contact knob 16 is attached.

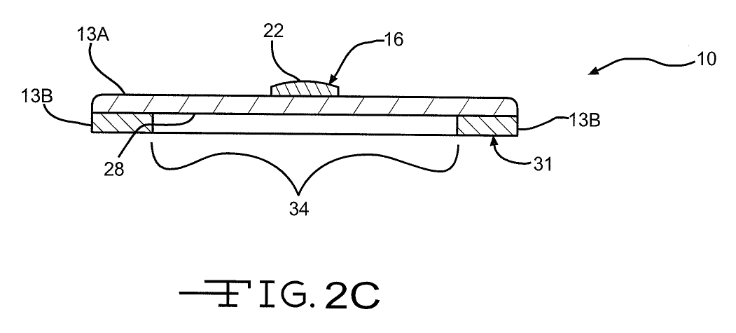

FIGS. 2a and 2b show another load cell 10 that is in keeping with the invention. FIG. 2b shows that the base 13 may be shaped to provide a recessed area 28. The recessed area 28 is defined in part by an annular lip 31 which extends from a central portion 34 of the base 13. In FIG. 2c, the base is formed from two base pieces 13A and 13B, and the annular lip 31 is provided by the base piece 13B. The annular lip 31 may be provided with through holes 37 that may be used for mounting the base 13 to a desired location. The strain gauges 19 are shown attached to the base 13 within the recessed area 28, and are thereby protected to some extent. In the embodiment depicted in FIGS. 2a, 2b, and 2c, the contact knob 16 is on a different side of the base 13 than the strain gauges 19.

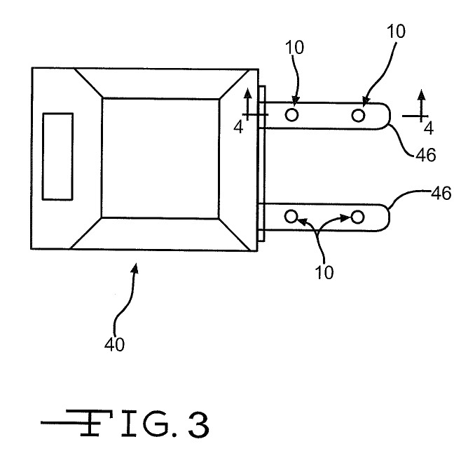

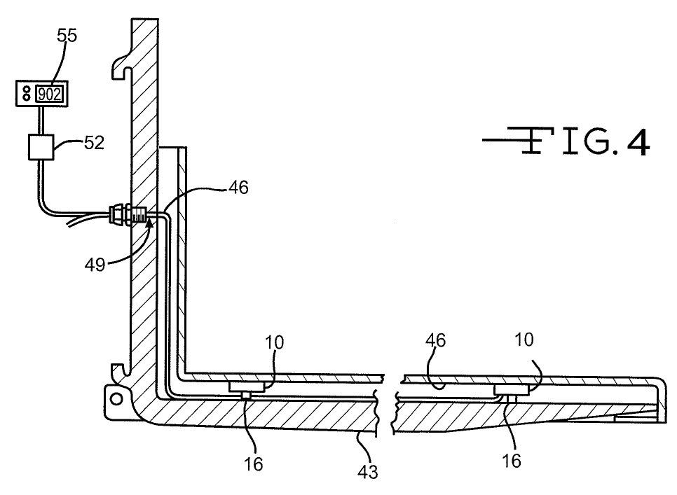

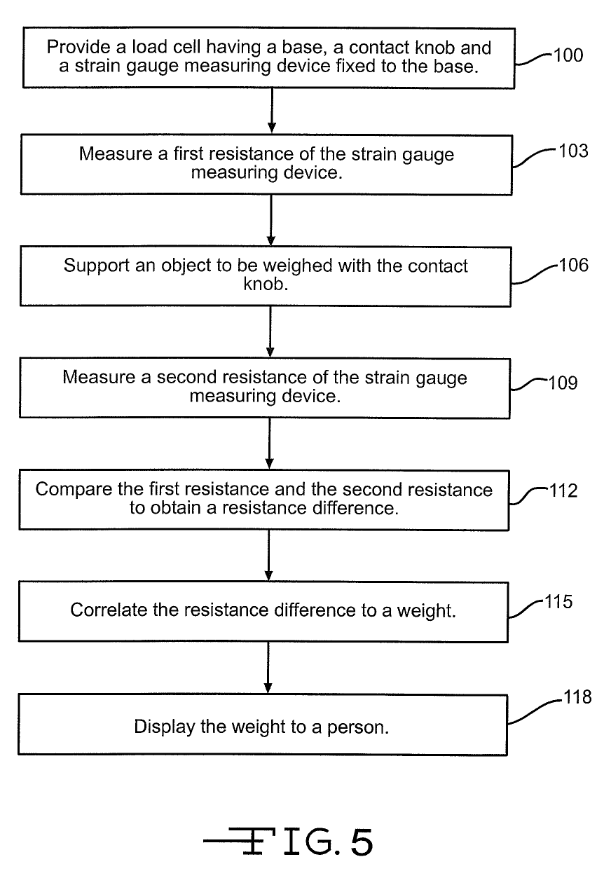

FIGS. 3 and 4 show how the load cell 10 of FIG. 2a might be used on a forklift truck 40. The contact knob 16 may be placed in contact with the tine 43, or with a cover 46, on which may be placed objects to be weighed. When objects are placed on the cover 46, the weight of the objects is supported by the contact knob 16. The central portion 34 of the base 13 is caused to flex and transfers the load to the annular lip 31. The flexing of the central portion 34 is sensed by the strain gauges 19.

The load cells 10 described above may be made to have a height of less than about 0.5 inches, and yet provide accurate weight readings in excess of 1,000 pounds. The small height of the load cell 10 makes it ideal for use in situations where there is a small amount of space. For example, often the tines 46 of a forklift truck 40 must be able to fit between an upper and a lower surface of a pallet, and in such a situation, there is a small amount of space. As such, forklift trucks have traditionally not placed load cells beneath the objects being lifted. Instead, traditional forklift truck design has placed load cells on other parts of the forklift truck 40, and these locations provide an indirect measurement of the weight of objects being lifted by the forklift truck 40, and therefore tend to be less accurate. By using a cover 46 to sandwich the load cell 10 between the cover 46 and the tine 43, the present invention permits the load cell 10 to be placed directly beneath the objects being weighed.

In another implementation of the load cell 10, a single strain gauge 19 may be fixed to the base 13 and placed on an end of a support pillar for a building. Three similar load cells 10 may be each fixed to their own pillar, and the four load cells 10 may be electrically connected so that the strain gauges 19 form a Wheatstone bridge. The resulting distribution of four load cells 10 on four pillars may be used to measure the weight applied to a surface supported by the pillars. By distributing the load cells in this fashion, a single analyzing circuit 52 may be used to measure the weight applied across a large area.

A transmission device 49 may be included. Such a transmission device 49 may be capable of transmitting a signal from the strain gauges 19 to an analyzing circuit 52, such as a voltmeter. The transmission device 49 may be an electric conductor extending between the strain gauge 19 and the analyzing circuit 52, and the wire may be capable of transmitting electricity between the analyzing circuit 52 and one or more load cells 10. Such a conductor may be routed from the load cells 10 through a hole in the base 13.

The invention may be embodied as a method. FIG. 5 depicts one such method. In that method, a load cell is provided 100. The load cell has a base, a contact knob and a strain gauge measuring device fixed to the base. The strain gauge measuring device may be a Wheatstone bridge, and it may be fixed to a side of the base that is different from the side from which the contact knob extends. A first resistance of the strain gauge measuring device is measured 103, and then an object to be weighed is supported 106 by the contact knob. Then a second resistance of the strain gauge measuring device is measured 109, and compared 112 to the first resistance to obtain a resistance difference. The resistance difference is correlated 115 to a weight. The weight is then displayed 118 to a person for example via a monitor 55.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A load cell, comprising:
a base;
a contact knob;
a strain gauge measuring device fixed to the base, the measuring device including at least one strain gauge;
a transmission device, the transmission device being capable of transmitting a signal from the strain gauge to an analyzing circuit.

2. The device of claim 1, wherein the transmission device includes conductors extending between the load cell and the analyzing circuit.

3. The device of claim 1, wherein the contact knob has a rounded surface.

4. The device of claim 1, wherein the contact knob and the base are an integral unit.

5. The device of claim 1, wherein the contact knob and the base are different pieces of material that have been attached to each other.

6. The device of claim 1, wherein the contact knob is on a first side of the base and the strain gauge is on a second side of the base.

7. The device of claim 1, wherein the strain gauge measuring device is a Wheatstone bridge.

8. A method of weighing, comprising:
provide a load cell having a base, a contact knob and a strain gauge measuring device fixed to the base;
measure a first resistance of the strain gauge measuring device;
support an object to be weighed with the contact knob;
measure a second resistance of the strain gauge measuring device;
compare the first resistance and the second resistance to obtain a resistance difference;
correlate the resistance difference to a weight;
display the weight to a person.
